(19) United States
(12) Patent Application Publication
(10) Pub. No.: US 2010/0295774 A1
(43) Pub. Date: Nov. 25, 2010

(54) Method for Automatic Mapping of Eye Tracker Data to Hypermedia Content

(75) Inventor: Craig Adam Hennessey, Vancouver (CA)

Correspondence Address: HANCOCK HUGHEY LLP, P.O. BOX 1208, SISTERS, OR, 97759, US

(73) Assignee: Mirametrix Research Incorporated, Vancouver (CA)

(21) Appl. No.: 12/727,284

(22) Filed: Mar. 19, 2010

Related U.S. Application Data
(60) Provisional application No. 61/216,456, filed on May 19, 2009.

(51) Int. Cl. G06T 7/00; G09G 5/00

(52) U.S. Cl. 345/156; 382/103

(57) ABSTRACT

A system for automatic mapping of eye-gaze data to hypermedia content utilizes high-level content-of-interest tags to identify regions of content-of-interest in hypermedia pages. User's computers are equipped with eye-gaze tracker equipment that is capable of determining the user's point-of-gaze on a displayed hypermedia page. A content tracker identifies the location of the content using the content-of-interest tags and a point-of-gaze to content-of-interest linker directly maps the user's point-of-gaze to the displayed content-of-interest. A visible-browser-identifier determines which browser window is being displayed and identifies which portions of the page are being displayed. Test data from plural users viewing test pages is collected, analyzed and reported.

### TECHNICAL FIELD

The invention relates to tracking and automatic mapping of eye-gaze data to hypermedia content, in particular content identified by high-level content-of-interest tags.

### BACKGROUND OF INVENTION

Modern eye-tracking systems are primarily based on video images of the face and eye. For examples of eye-gaze trackers see U.S. Pat. No. 4,950,069, U.S. Pat. No. 5,231,674 and U.S. Pat. No. 5,471,542.

Eye-gaze tracking has been shown to be a useful tool in a variety of different domains. Eye-gaze can be used as a control tool or as a diagnostic tool. As a control tool, eye-gaze can directly replace the control of a typical mouse cursor, see U.S. Pat. No. 6,204,828 for example, or used more subtly in gaze contingent displays where the region of a display closest to the point-of-gaze is rendered with higher resolution (as in U.S. Pat. No. 7,068,813) or downloaded faster (as in U.S. Pat. No. 6,437,758). When used as a diagnostic tool, eye-gaze is typically recorded along with a video of what the user was looking at. Post processing is then performed to link the eye-gaze data to the content observed by the user on the display. The resulting data provides information on what the user spent time looking at, what attracted the user's eyes first, last, and other metrics.

A major difficulty in the diagnostic use of eye-gaze is that eye-gaze is tracked on the surface of a display, while of main interest is where the eyes were looking in the scene shown on the display. In a dynamic display, such as a computer screen, significant effort is required to link the eye-gaze on the screen to the constantly changing content displayed. To illustrate, if the eye is observing a fixed point on the screen while viewing a hypermedia page in a browser, scrolling the page up or down will change the content the user is observing, without the point-of-gaze on the screen ever changing. Linking eye-gaze (typically recorded at 60 to 120 Hz) to a video recording of the user's viewing scene (typically recorded at 24 to 30 Hz) is performed manually on a frame by frame basis to identify what the eye was looking at each point in time. As is obvious, this manual process requires considerable effort and is only practical for short recording sessions.

An alternative to the manual approach was proposed by Edwards in U.S. Pat. No. 6,106,119, in which eye-gaze data and screen captures of a World Wide Web browser display were recorded, along with event data such as scrolling. The eye-gaze data may then be mapped to the corresponding portion of the image that was on the display by also playing back the recorded events in the appropriate time sequence. The difficulty with this method is that the eye-gaze data is only linked to the screen captured image. What is actually shown in the recorded image (the content-of-interest) that the user was observing must still be determined. One proposed solution is the manual creation of templates outlining the regions of the content-of-interest in the screen captures of the page. This solution is not practical when considering the multitude of pages that make up a website. In addition when comparing results from users with different displays, templates would be required for every combination of font size, screen size, resolution, and any other variation in the way a page might be displayed.

Another technique proposed for improved mapping of eye-gaze to content-of-interest was outlined by Card et al, U.S. Pat. No. 6,601,021 in which eye-gaze, event data, and an exact copy of the hypermedia that was displayed are all recorded. This method requires that the recorded page be restored from memory exactly as previously viewed and the event data re-enacted, at which point the eye-gaze data is mapped to elements-of-regard derived from the document-object-model (DOM) page elements. The proposed method also suffers from the same difficulty as Edwards when comparing data collected with different displays (font and screen sizes, resolutions, etc). As well, further processing is still required to determine what content-of-interest was observed from the DOM page elements.

A method that links eye-gaze data to content-of-interest is clearly needed to allow for comparison of eye-gaze data between users who may be using a range of different computing hardware and displays. As well, excessive post processing of large quantities of recorded data is time consuming and processor intensive, limiting study duration and size.

### BRIEF DESCRIPTION OF THE DRAWINGS

The invention will be better understood and its numerous objects and advantages will be apparent by reference to the following detailed description of the invention when taken in conjunction with the following drawings.

FIG. 1 schematically depicts a method for automatic mapping of eye tracker data to hypermedia content using tags to specify content-of-interest and a visible browser identifier method to determine which content is visible on the screen according to a particular embodiment of the invention;

FIG. 2 is an example of tags specifying content-of-interest according to a particular embodiment of the invention;

FIG. 3 is a schematic illustration of an example hypermedia page with the content-of-interest tag identifiers shown;

FIG. 4 schematically depicts a method for determining the visible browser tab or window for mapping eye-gaze data to hypermedia content;

FIG. 5 is an example of a display with two browser windows, with each browser window having two browser tabs with associated content;

FIG. 6 is a schematic illustration of a dashboard displaying the resulting data according to a particular embodiment of the invention.

FIG. 7 is a schematic illustration of an implementation of one embodiment of the invention.

FIG. 8 is a graphical illustration of a typical analysis that may be performed with an embodiment of the invention.

### DETAILED DESCRIPTION

Eye-tracking studies are a useful tool in a diverse number of applications, including developing a better understanding on how to design user interfaces, analyzing advertising media for effectiveness (for example, placement and content) and performing market research on what catches and holds a user's attention.

While eye-tracking studies provide useful data they are difficult to undertake, in particular due to the difficulty in interpreting the resulting eye-gaze data in the context of the content displayed to the user. Eye-tracking data typically consists of a sequence of point-of-gaze coordinates on the display screen the user was observing. The position of the eye-gaze on the physical screen must then be linked to the content-of-interest that was displayed on the screen at that position.

An example of an eye-gaze study using a static page would be to display an advertisement with three content-of-interest areas; a company logo (LOGO), a picture of the product (PRODUCT) and a paragraph of text describing the product (DESCRIPTION). The goal of the study might be to understand which of the three content-of-interest regions caught the eye first, held the attention the longest, and to verify that the company logo was observed. Another example of an eye-gaze study using a website could include pages consisting of a header with the company logo (HEADER), a banner advertisement (ADVERTISEMENT), navigation elements (NAVIGATION) and the page information (INFORMATION). The goal of the website eye-gaze study might include determining when and for how long the user observed the advertisement and to confirm the user spent minimal time looking at the navigation elements.

In the case of the static page example above there is no dynamic content, simplifying the mapping between point-of-gaze estimates on the screen to the known content-of-interest areas. The point-of-gaze data is determined with respect to a fixed origin, typically the top left corner of the screen. The offset between the screen origin and the page origin is used to perform the mapping of point-of-gaze to content-of-interest areas on the page. The relation between the point-of-gaze on the screen POG_{screen} and the point-of-gaze on the page displayed on the screen POG_{page} follows a simple translation equation as follows:

$$[ \begin{matrix}{POG}_{page\_x} \\ {POG}_{page\_y}\end{matrix} ] = [ \begin{matrix}{POG}_{screen\_x} \\ {POG}_{screen\_y}\end{matrix} ] - [ \begin{matrix}{page}_{orig\_x} \\ {pagee}_{orig\_y}\end{matrix} ]$$

The content-of-interest on the page may be defined by a geometric region, for example a rectangle, circle, or general polygon, although any shape may be used. Once the point-of-gaze has been translated to page coordinates it may be tested to see if it is within a content-of-interest region. Most often the content-of-interest region is a rectangle on the page defined by the coordinates of the top, bottom, left and right extents of the rectangle. To determine if the point-of-gaze is within the rectangle the test is:

If (POG_{page}_{_{—}}ₓ > CONTENT_{left}) AND (POG_{page}_{_{—}}ₓ < CONTENT_{right})
AND
(POG_{page}_{_{—}}_{y} > CONTENT_{bottom}) AND (POG_{page}_{_{—}}_{y} < CONTENTₜₒₚ)
THEN the POG is inside CONTENT rectangle

For circular content-of-interest regions (defined by a center point and a radius) the test is to determine if the POG is within the circle:

If (squareroot ((POG_{page}_{_{—}}ₓ − CONTENT_{center}_{_{—}}ₓ)\hat{ }2 +
(POG_{page}_{_{—}}_{y} − CONTENT_{center}_{_{—}}_{y})\hat{ }2) < CONTENT_{radius})
THEN POG is inside CONTENT circle

For content-of-interest regions defined by general polygons, the well know ray casting and angle summation techniques may be used.

The point-of-gaze may be associated with a particular content region if it is on or near the boundary of the content region, rather than only if within the region. This may be helpful in the event of offset errors in the estimated point-of-gaze on the display. To associate the point-of-gaze with nearby content, the tests are modified to determine if the point-of-gaze is near the perimeter of a region.

When dynamic content is shown the mapping becomes more involved. For example, if the above advertisement example were shown on a larger page, the user might be able to scroll the advertisement up or down, changing the position of the page origin with respect to the screen origin. In a web browsing environment, in addition to horizontal and vertical scrolling, the user may also click on hyper links to load new pages, go back to previous pages, open and close new browser windows and tabs within those windows, resize the browser and change the font size among many other variations that change how content is displayed.

Similarly, when trying to aggregate eye-gaze tracking data results from multiple subjects, such as when performing a user study with a large number of participants the users may be using different screen resolutions, screen shapes and screen sizes. Subjects who browse the same page may not even get the same page content due to the dynamic nature of the web. Given all the potential variations in the way content-of-interest may be displayed on the screen, clearly an improved system and method is needed to determine the mapping between point-of-gaze data and content-of-interest.

In the present invention, the recording of the low level data such as screen shots or exact copies of pages are not required. High-level content-of-interest is directly identified in a page and the mapping of eye-gaze to identified content-of-interest is performed automatically while the user browses. Comparison and aggregation of data between users is performed on the eye-gaze linked to content-of-interest data.

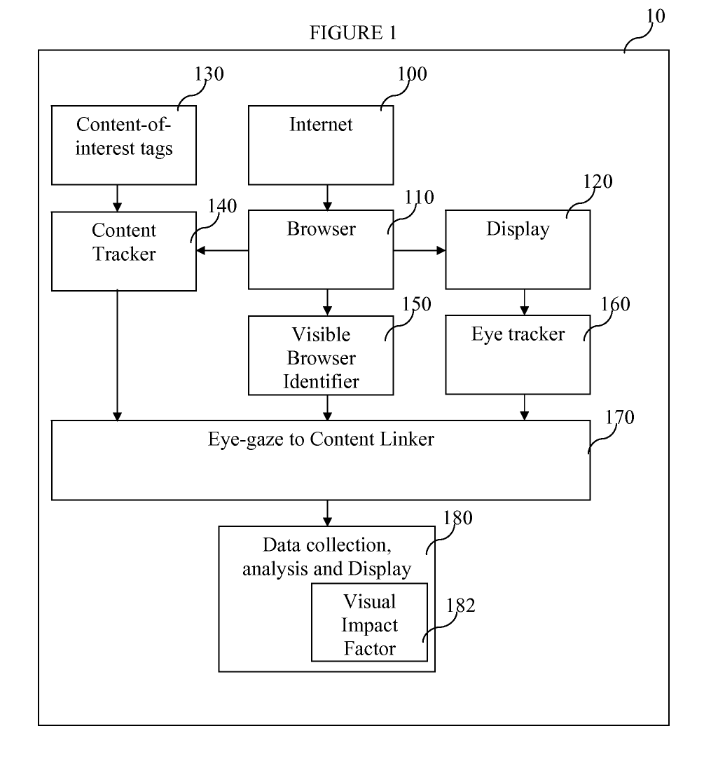

FIG. 1 schematically depicts a method 10 for automatic mapping of eye tracker data to hypermedia content using high level content-of-interest tags.

### Internet 100, Browser 110, Display 120

In FIG. 1, the Internet 100 may be any system for providing hypermedia data and the browser 110 may be any system for displaying said hypermedia data. For illustrative purposes herein the Internet is the World Wide Web (WWW or just web) and the browser is Microsoft® Internet Explorer. In the present invention the display 120 is a computer screen of any resolution, shape and size used to present content from internet 100 to the user via the user's browser 110. In practicing the present invention any other form of display such as a projector may be used.

### Content-of-Interest Tags 130

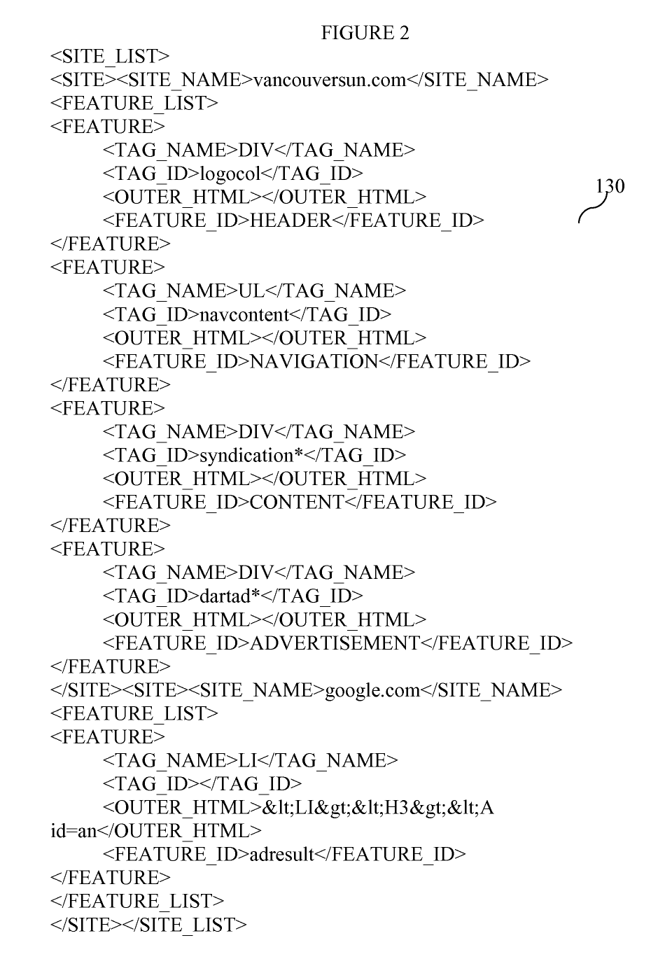

The content-of-interest tags 130 are specified before an eye-gaze tracking study begins. The tags are used to identify the content-of-interest embedded in the hypermedia and associate it with a high level identifier. Following the previous examples of a website, the high-level content-of-interest tags would be HEADER, BANNER, NAVIGATION and INFORMATION. The content-of-interest tags are described further in the discussion of FIG. 2.

### Content Tracker 140

In the present invention the content tracker 140 uses the Microsoft® Component Object Model (COM) interface to access the Document Object Model (DOM) of the hypermedia page, although any other method for providing access to the DOM may be used. The content tracker 140 uses the content-of-interest tags 130 to identify matching elements in hypermedia content and the resulting portion of the page occupied by the content-of-interest. To identify the content-of-interest on a page, the content tracker uses the document-object-model to generate a list of all of the elements on a page. Each element is analyzed in turn to determine the position and size of the element when rendered on the page. Tracking content through tags is particularly effective with the increasing use of media content layout techniques such as cascading style sheets (CSS) which define content layout based on hyper media tags such as DIV.

Often only a portion of the entire page is visible on the display at one time, and the user must scroll vertically or horizontal to view the remainder of the content. The visible browser identifier method described in the following section is used to determine which part of a page is visible on the display at any one time. The position of the page elements, along with the portion of the page that is currently visible is used to link eye-gaze data to content-of-interest as described further in the Eye-gaze to Content Linker section below.

Most pages result in a fixed position and size for each element on the page when rendered. It is possible however that the position of elements change due to events such as user action, for example changing the browser window size, font size, or screen resolution. As well, modern pages may reconfigure themselves using techniques such as Javascript or AJAX. To account for reconfigurable pages, the identified page element positions are time-stamped by the content tracker 140 and the content tracker is continuously executed to maintain the most accurate positions of page elements. Alternatively the content tracker 140 may be signaled with events indicating that the page element positions should be updated.

### Visible Browser Identifier 150

Browsers often allow multiple instances to run at the same time (browser windows) with each browser window composed of one or more tabs, each possibly showing a different page. Any of these pages may potentially be displayed on the screen, which requires the eye-gaze tracking system to know which page is currently visible in order to correctly map the eye-gaze data to the content displayed.

Previous methods have not addressed this problem and instead have simply restricted the user to a single browser tab that must always remain visible on the display. With the visible browser identifier method presented here, these restrictions are removed allowing the user much greater freedom in the operation of the computer and a more natural computing experience. The visible browser identifier method determines the location of all browser windows (and browser tabs within the window), as well as which browser tab is visible. For the visible browser, the visible browser identifier method also determines which portion of the page is shown if the page is larger than the display.

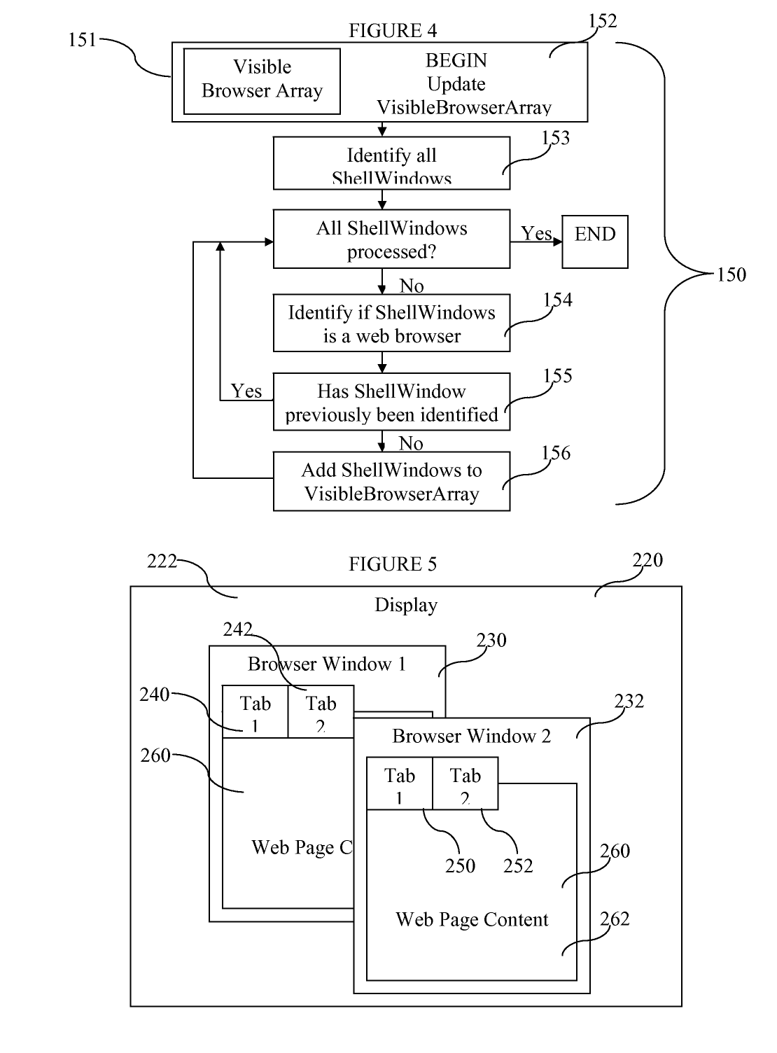

With reference to FIG. 1, the visible browser identifier 150 tracks events that affect what is displayed, such as maximizing, minimizing, moving and resizing the window, vertical and horizontal scrolling, hyperlink transfers to new pages, and changes in the active browser window and tab. The operation of the visible browser identifier 150 is described further in the discussion of FIG. 4.

### Eye-Gaze Tracker 160

The eye-gaze tracker 160 determines the point-of-gaze of the user's eyes on the display with respect to the origin of the screen. The screen origin is typically located at the top left of the display—this is illustrated schematically in FIG. 5 with reference number 222. In the present embodiment the eye-tracker 160 preferably is a non-contact system where video images of the user's face and eyes are captured and the image features used to compute the point-of-gaze on the screen are determined. A binocular point-of-gaze estimation system is used to determine the point-of-gaze on the screen for each eye, and the average of the left and right eye point-of-gaze estimates is used as the point-of-gaze for the user. The eye-tracker 160 generates a continuous stream of point-of-gaze estimates at 60 Hz. It will be appreciated that other eye-gaze tracker methodologies such as monocular trackers, may be employed in the present invention.

In addition to eye-gaze data the tracker also records the mouse cursor position and events, such as left click, right click, double click, as well as keyboard input. Knowledge of these additional user inputs is also desirable when analyzing human computer interfaces.

### Point-of-Gaze to Content-of-Interest Linker 170

The point-of-gaze to content-of-interest linker 170 performs the mapping of the point-of-gaze (POG) on the display screen to the point-of-gaze on the current visible page identified by the Visible Browser Identifier 150. One possible form of the mapping equation is shown as follows

$$[ \begin{matrix}{POG}_{page\_x} \\ {POG}_{page\_y}\end{matrix} ] = [ \begin{matrix}{POG}_{screen\_x} \\ {POG}_{screen\_y}\end{matrix} ] - [ \begin{matrix}{page}_{orig\_x} \\ {page}_{orig\_y}\end{matrix} ] + [ \begin{matrix}{scroll}_{horizontal} \\ {scroll}_{vertical}\end{matrix} ]$$

All eye-gaze data mapped to the page that is within the boundary of a particular content-of-interest region on that page is linked to that content for further analysis. The same procedure is used to map the mouse cursor screen position to the position on the page.

### Data Collection, Analysis and Display 180

With the eye-gaze mapped to content of interest at 170, a number of useful statistics may be developed at the data collection, analysis and display shown at 180, including the Visual Impact Factor 182, which is defined as a metric indicating the visual impact of a particular content-of-interest on the viewer. The Visual Impact Factor 182 may include metrics such as the total time spent viewing a particular content-of-interest, the time spent viewing a particular content-of-interest as a percentage of total page viewing time, what content-of-interest was viewed first, and other statistics based on the data. The Visual Impact Factor 182 along with any other statistics computed on the eye-gaze data may be recorded for further aggregation with multiple subjects to provide greater statistical power.

By linking eye-gaze directly to content-of-interest, comparisons between subjects using different displays can be made directly. For example, a subject using a 24 inch screen and a resolution of 1920×1200 pixels may have spent 4% of their time on a page viewing the top banner advertisement, while a second subject using a 17 inch screen and 1280×1024 pixel resolution may have spent 3% of their time viewing the same advertisement. Comparison and aggregation of data between these subjects need only consider the percent viewing time of the content-of-interest, independent of screen size and resolution.

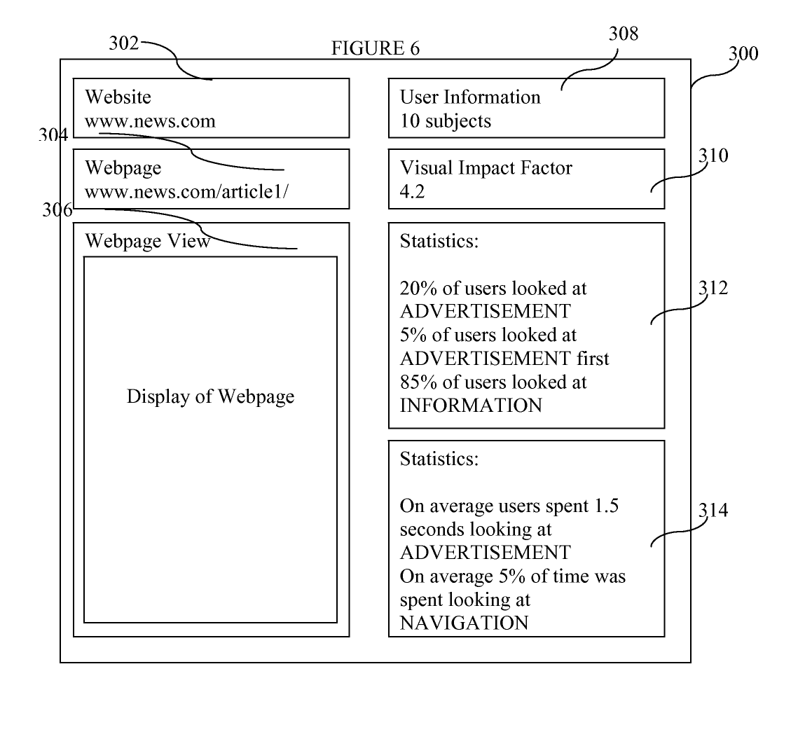

The presentation of study results will be discussed further in the discussion on FIG. 6.

FIG. 2 shows an example of content-of-interest tags 130. In this particular embodiment of the invention the list of tags is contained within an XML document. Note that because the XML format was used, certain characters are encoded, for example ‘<’ and ‘>’ in the identifier text are converted to ‘&lt;’ and ‘&gt;’ respectively.

In the embodiment shown, a SITE_LIST contains a list of sites of interest for the eye-gaze tracking study. The list of sites may include all sites on the internet, or be more narrowly focused, such as all pages from google.com. Wild cards may also be used in specifying which websites to analyze, for example *.google.com includes sites like www.google.com and maps.google.com. Subdirectories of web sites may also be specified such as www.news.com/articles/and www.stocks.com/technology/.

For each SITE in the SITE_LIST a FEATURE_LIST provides the content-of-interest tags needed to identify particular content on the pages. In the present embodiment of the invention a given content FEATURE may be specified by any combination of identifiers such as TAG_NAME, TAG_ID, and OUTER_HTML. Other identifiers may also be used such as INNER_HTML. The TAG_NAME corresponds to HTML tags such as DIV, A, IMG, UL, etc., while the TAG_ID is most often specified by the page designer such as logo, navigation, content, advertisement, etc. Each content-of-interest tag is also assigned a high level identifier name or FEATURE_ID that represents the high level content-of-interest.

For many page elements only the TAG_NAME and ID are used, particularly for pages that use the DIV and ID HTML elements to identify placement of content on a page, a technique commonly used with Cascaded Style Sheets (CSS). The OUTER_HTML identifier corresponds to the HTML code used to define the particular page element and can be used to identify content-of-interest with non-unique TAG_NAME or TAG_ID identifiers.

To further aid in identifying page elements, each of the feature tags may be modified with control commands to specify how the search for the feature tag takes place. A number of different search commands exist, two examples of which are EXACT for an exact match and START for matching only the start of the identifier text. In the present embodiment of the invention, EXACT is the default search command. For example, to identify an article heading H1 as content-of-interest, the content-of-interest tag:

### <TAG_NAME CONTROL=″EXACT″>H1</TAG_NAME>

would correctly identify the heading specified by the following code:

### <H1>Heading 1 Content Description</H1>

If the content-of-interest tag was

### <TAG_NAME CONTROL=″START″>H</TAG_NAME>

the content-of-interest would identify the H1 tag name as well as all other tags beginning with H, such as H2, H3, H4, HR, HEAD, etc.

To provide even greater flexibility when identifying content-of-interest, the feature tags may be combined using logical operators such as AND, OR, and XOR. Combined feature tags allow multiple elements to be joined into a single region defining content-of-interest.

A region specified by a content-of-interest tag 130 can also be subdivided and eye-gaze data linked to the sub-regions of the content-of-interest. The use of XML as the content tag format allows addition modifiers to the content-of-interest tag to specify such sub regions. For example if the content-of-interest was an image of size 600×40 pixels with two distinct rectangular regions in the image, a top region of 600×20 and a bottom region of 600×20, these two sub regions could be specified with the following modifiers:

<SUB_REGION X=“0” Y=“0” WIDTH=“600”
HEIGHT=“20”>top_of_image</SUB_REGION>
<SUB_REGION X=“0” Y=“20” WIDTH=“600”
HEIGHT=“20”>bottom_of_image</SUB_REGION>

In addition to rectangular sub-regions, other geometric shapes are possible for defining sub-regions such as circles, ellipses and polygons among others. As well, for dynamic content-of-interest such as video, these sub-regions may also include timestamp data to track the sub-region in the content-of-interest over time.

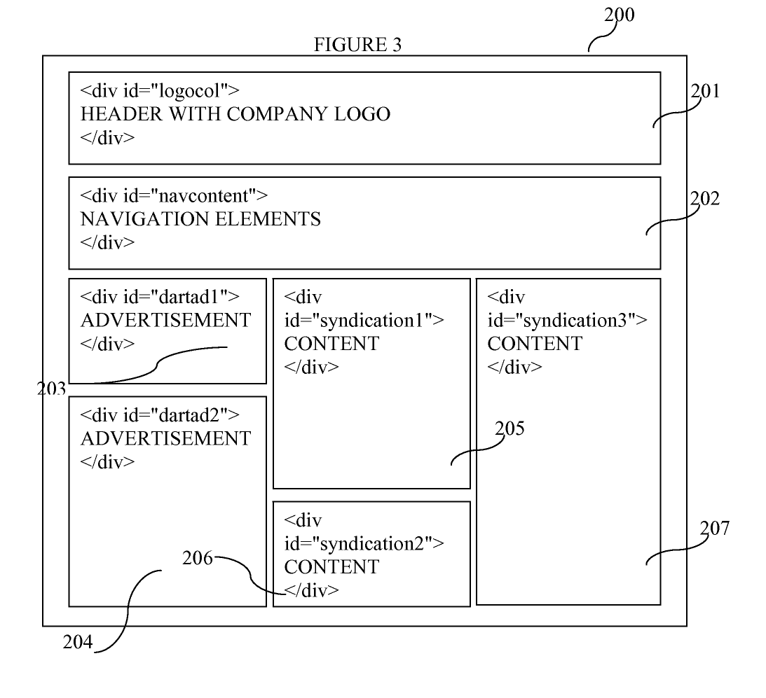

FIG. 3 illustrates a graphical example of the HTML code that could comprise a page 200 for a media portal including the placement of the DIV and ID statements. For illustrative purposes, page 200 includes the following page elements: header with company logo 201, navigation elements 202, advertisement 203, advertisement 204, content 205, content 206 and content 207.

FIG. 4 is a flow diagram illustrating the visible browser identifier 150 and the associated method for identifying the list of active browser windows and tabs. An example of active browsers shown on a display 220 is shown in FIG. 5 with two browser windows 230 and 232, with each browser window having two tabs, identified with reference numbers 240, 242, and 250, 252, respectively. Each browser tab 240, 242, 250 and 252 includes content 260. Some browsers may not support tabs and therefore the descriptor “browser window” and “browser tab” may be used interchangeably, as there is effectively only one browser tab per browser window.

In the embodiment of the invention illustrated in FIG. 4 the list of active browser tabs is stored in an array, VisibleBrowserArray 151. In practicing the invention other data structures may be used such as linked-lists. The VisibleBrowserArray 151 contains a list of all browsers tabs currently active, as well as a flag indicating if the browser tab is visible. The visible browser identifier 150 also keeps track of the portion of the page that is currently visible due to scrolling.

Events are used to trigger the visible browser identifier 150 to track changes in the active state of the browsers and pages. The events that may be triggered at the level of the browser (events that affect the operation of the browser) include Registering event when the users starts a new browser window or tab and Revoking events triggered when the user closes a browser window or tab. Events occurring within a browser (events that effect the pages within the browser window) include Quit events when the browser is closed, Scroll events when pages are scrolled and Navigate events when the browser navigates to new pages. Other events may be also used to track the changes in browser and page status.

The flow diagram shown in FIG. 4 is executed when the system operations begins, which initializes the Update VisibleBrowserArray 152 with all currently active browsers. A list of all active windows (and corresponding tabs within the window) 153 (i.e., Identify all ShellWindows) is collected from the operating system and each window is inspected to determine if the window is a web browser or some other browser such as a file browser 154. If the window is a browser then the unique browser ID (in this case a pointer to the browser handle) is compared at 155 with all browser ID's already in the VisibleBrowserArray 151. If no match is found the new browser is added to the VisibleBrowserArray at 156 and the process repeats with the next window until all windows are processed. The Update VisibleBrowserArray 152 is executed on all Registering events when a new window has been created. When a Revoked event is called indicating a window or tab has closed, the array is searched for browser windows and tabs that are no longer active (as specified by the Quit event below) and when found are removed from the VisibleBrowserArray 151.

The events within each browser added to the VisibleBrowserArray 151 are also tracked. The Quit event is called when the user closes a browser window or tab. When the Quit event occurs, the browser is flagged as inactive and is subsequently removed from the VisibleBrowserArray 151 by the Revoked event described above. The Scroll event is used to keep track of the current scrolled position of a page, and the Navigate event is used to keep track of the active page in the browser tab.

A polling sequence is used to determine which browser tab is in the foreground of the display and is visible to the user. To determine which, if any, browser tab is visible to the user the handle to the ForegroundTAB ID (e.g., reference number 262, FIG. 5) is periodically checked and compared with the handles of the browsers in the VisibleBrowserArray 151. If a match is found the browser tab is flagged as currently visible. When the eye-tracker 160 has generated a new point-of-gaze estimate, the linker 170 uses the visible browser identifier 150 to determine if a browser window and tab was visible and if so, what portion of the page was visible to the user. The point-of-gaze on the screen is then mapped to the point-of-gaze on the visible page.

Event driven operation and polling driven operation of the processes described may be used interchangeably.

FIG. 6 shows an illustration of one embodiment of a dashboard 300 based report of an eye-gaze study. Reports based on the invention presented here may display the results in text, graphical and other forms useful to the user to interpret the results. Text based reports are typically used to quantitatively summarize data about a particular content-of-interest element, an entire page, an entire website or group of websites, for single or multiple subjects. Graphical display is typically used to qualitatively summarize data about a single page for single or multiple subjects by overlaying eye-gaze results on the page.

The dashboard 300 shown in FIG. 6 includes several graphical elements that may be useful to the user. It will be appreciated that the specific analytical elements included in a dashboard will depend on the particular user's needs and other factors, and that the graphical and textual elements in FIG. 6 are for illustrative purposes only. Thus, dashboard 300 includes information identifying the website analyzed at 302 and the particular web page 304. A graphical display of the web page 304 is shown at 306, including specific fields defining content of interest. Statistical and analytical data are displayed on the right hand side of the dashboard 300, and includes user information 308 such as the number of users participating in the study, the Visual Impact Factor 182 described above, and relevant statistics at 312 and 314. Numerous other metrics may be included in a report to the user such as dashboard 300, and as noted previously, may be provided either graphically or textually.

For graphical presentation of the results, the desired analysis page such as dashboard 300 may be re-downloaded at the time of display, as the invention does not require recording and saving of all pages viewed.

The content-tracker 140 is used to identify any content-of-interest areas on the analysis page such as dashboard 300 as was done in the eye-gaze study. If any content-of-interest on the analysis page matches with content-of-interest from the eye-gaze study, the content on the analysis page is modified to highlight the study results. Modification of the analysis page may color an outline or overlay of the content-of-interest using a temperature based color scale. For example, content-of-interest that was viewed infrequently may be colored a cool blue or gray while frequently viewed content is colored a hot red. The modified analysis page is then displayed to the user or saved for later use.

For the display and use of text based results, minimal additional processing is required as there is no need to analyze previously recorded screenshots or HTML code. It is also not necessary to determine how the content-of-interest was originally displayed to the user in terms of event playback, screen size, resolution, and other display parameters. The Visual Impact Factor statistics for a content-of-interest element include time spent viewing the element, the time spent viewing an element as a percentage of total page viewing time, the order in which elements were viewed, and the frequency an element was observed. An example report illustrating some of the Visual Impact Factor statistics may appear as follows:

20% of users looked at ADVERTISEMENT
5% of users looked at ADVERTISEMENT first
85% of users looked at INFORMATION first
On average users spent 1.5 seconds looking at ADVERTISEMENT
On average 5% of time was spent looking at NAVIGATION

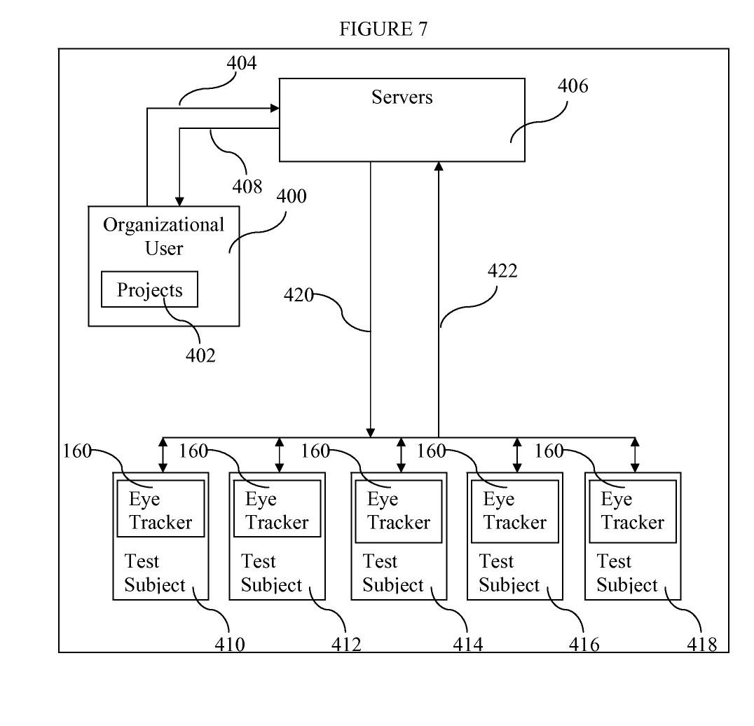

A specific implementation of an embodiment of the present invention is illustrated schematically in FIG. 7. Generally described, in FIG. 7, organizational users 400 (which could be, for example, advertisers, market research firms, etc.) generate projects 402. Projects 402 could be for example plural versions of an advertisement that the organizational user 400 wants to be evaluated for efficacy. The organizational user may want to determine which elements of the various advertisements are viewed for the longest period of time in order to determine which graphical elements are most attractive to a target audience. The organizational user 400 uploads (404) those projects to servers 406. At servers 406 the projects 402 are processed for display on a web page as detailed above, including addition of content of interest tags. Plural test subjects are represented by reference numbers 410 through 418—although five test subjects are shown in FIG. 7, the number of test subjects could be significantly greater. The test subjects define a panel of users such as home users whose computers have been equipped with eye trackers 160 and who are familiar with testing protocols. The test subjects are notified of a pending test and browse to a designated test web site 420, which typically would be hosted on servers 406 and which includes the projects 402.

Each test subject's eye-gaze data while viewing a project 402, such as eye-gaze positions and eye-gaze to content of interest data, are collected 422 and analyzed at servers 402 according to the methodology described above. Data from plural test subjects is aggregated at servers 406 and reports are generated (such as dashboard 300) and transmitted (408) back to the users 400.

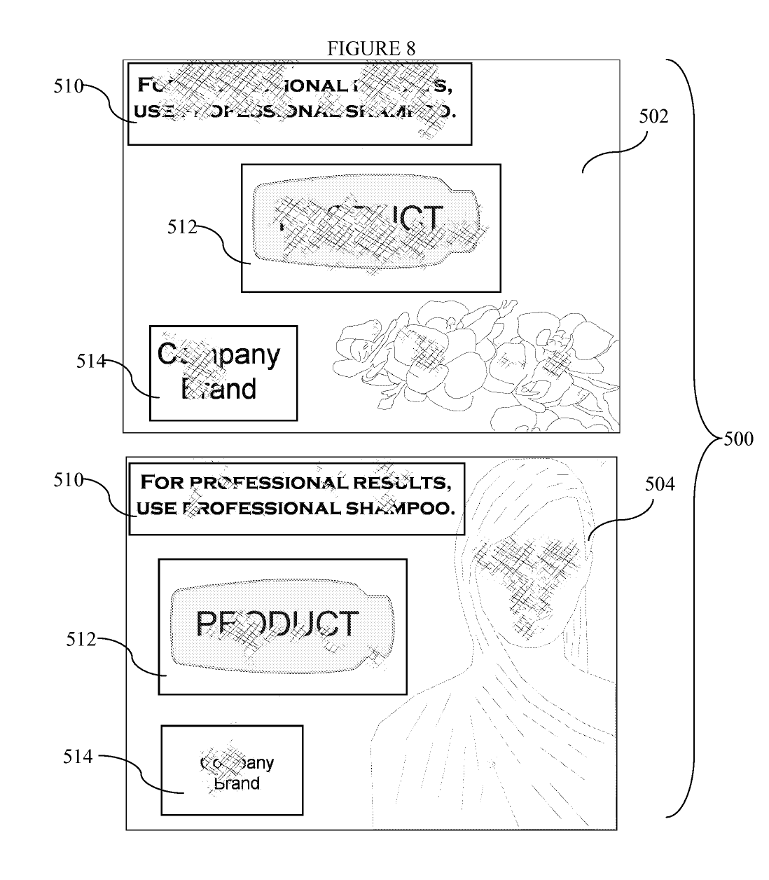

An illustrative example 500 of the embodiment discussed above is shown in FIG. 8. For a project 402, plural content-of-interest are represented by reference numbers 502 and 504—although two advertisements are shown in FIG. 8. In the project 402 the advertisement images may be shown as the content-of-interest on a webpage. The advertisements may be further divided into sub-regions of interest, identified such as TAGLINE 510, PRODUCT 512 and BRAND 514. Since the project is predefined and the content-of-interest resides on the servers 406, these sub-regions may be defined before or after the data is collected. Upon completion of the data collection process 422 the data may be processed to generate quantitative statistics or graphical representations as previously discussed. In the example 500 a graphical representation of the data is shown indicating areas viewed longer with cross hatching. A more common graphical representation called a heatmap uses color to indicate the regions viewed longer with a hotter (redder) color. In the example shown, the content 502 and 504 were images, however alternative types of content are also possible such as video, text, Flash content or any other media.

While a number of statistics based on the data generated by the proposed method have been illustrated, along with methods for the display of the results, it should be noted that other methods for analysis and display may also be used in practicing the present invention. For example, while there are innumerable statistical metrics that may be useful to analyze various parameters, some of the most commonly used metrics include the order and sequence in which a user's gaze moves from and/or about different regions and sub-regions of interest on a page, the percentage of time that a particular content-of-interest was viewed, the overall percent of subjects who viewed the content-of-interest, the average time duration before the content-of-interest was first viewed, the average number of times content-of-interest was revisited, and the percentage of subjects who revisited a content-of-interest.

While the present invention has been described in terms of preferred embodiments, it will be appreciated by one of ordinary skill in the art that the spirit and scope of the invention is not limited to those embodiments, but extend to the various modifications and equivalents as defined in the appended claims.

1. A system for automatic mapping of eye-gaze data, comprising:
an eye-gaze tracker that determines a user's point-of-gaze on a display;
at least one tag contained in a hypermedia page displayed on the display to identify predetermined content-of-interest in the page;
a content tracker to identify the position of content-of-interest on the displayed hypermedia page; and
a linking tool that directly maps the user's point-of-gaze on the display to the displayed content-of-interest.

2. The system for automatic mapping of eye-gaze data according to claim 1 wherein the display includes at least one visible browser window and tab, and further including a visible-browser-identifier that determines which browser window and tab is being displayed and identifies which portions of the hypermedia page are being displayed.

3. The system for automatic mapping of eye-gaze data according to claim 2 wherein the visible browser window includes plural tabs and the visible-browser-identifier is configured for determining which tab is being displayed.

4. The system for automatic mapping of eye-gaze data according to claim 1 wherein the locations of content-of-interest identified by the content tracker are time-stamped and the content-tracker is continuously executed to update and maintain the position of content-of-interest.

5. The system for automatic mapping of eye-gaze data according to claim 3 in which the linking tool maps the user's point-of-gaze on the display to the displayed content-of-interest by mapping the point-of-gaze on the display to the point-of-gaze on the displayed page identified by the visible-browser-identifier.

6. The system for automatic mapping of eye-gaze data according to claim 1 including an input device controlling a cursor and wherein the eye-gaze tracker is configured to track cursor position.

7. The system for automatic mapping of eye-gaze data according to claim 1 wherein the tag contained in a hypermedia page to identify predetermined content-of-interest in the page is divided to identify sub-regions of the content-of-interest so that eye-gaze data may be linked to an identified sub-region.

8. The system for automatic mapping of eye-gaze data according to claim 3 in which the visible-browser-identifier is configured for tracking which portion of a page is currently visible on the display as the page is scrolled.

9. The system for automatic mapping of eye-gaze data according to claim 8 wherein the visible-browser-identifier is configured for tracking changes in the status of browsers and pages.

10. A method for collecting, analyzing and displaying point-of-gaze and eye-gaze to content-of-interest data, comprising:
a) defining content-of-interest tags, where each content-of-interest tag is associated with a portion of a displayed hypermedia page that defines content-of-interest;
b) determining a user's point-of-gaze on the displayed hypermedia page with an eye-gaze tracker;
c) identifying the position of the content-of-interest tags on the displayed content-of-interest; and
d) directly mapping the user's point-of-gaze to the displayed content-of-interest.

11. The method for collecting, analyzing and displaying point-of-gaze and eye-gaze to content-of-interest data according to claim 10 including the step of identifying which portion of the hypermedia page is being displayed.

12. The method for collecting, analyzing and displaying point-of-gaze and eye-gaze to content-of-interest data according to claim 11 including continuously time-stamping the identified positions of the content-of-interest tags on the hypermedia page being displayed.

13. The method for collecting, analyzing and displaying point-of-gaze and eye-gaze to content-of-interest data according to claim 10 including the step of tracking the position of a cursor and tracking browser events.

14. The method for collecting, analyzing and displaying point-of-gaze and eye-gaze to content-of-interest data according to claim 10 including the step of collecting eye-gaze to content-of-interest data from plural test subjects, analyzing the data from the plural test subjects and displaying the analysis.

15. A method for collecting, analyzing and displaying point-of-gaze and eye-gaze to content-of-interest data, comprising:
a) installing eye-gaze trackers at multiple user locations;
b) generating hypermedia test pages to be analyzed;
c) embedding content-of-interest tags into predetermined portions of the hypermedia test pages and associating each content-of-interest tag with a portion of the hypermedia test page that defines content-of-interest;
d) allowing multiple users with eye-gaze trackers to access the hypermedia test pages and allowing users to view the hypermedia test pages;
e) directly mapping each user's point-of-gaze on the hypermedia test pages as measured by the eye-gaze trackers to the content-of-interest tags to generate eye-gaze to content-of-interest data; and
f) recording point-of-gaze and eye-gaze to content-of-interest data generated in step e.

16. The method for collecting, analyzing and displaying point-of-gaze and eye-gaze to content-of-interest data according to claim 15 including for each user identifying and recording the position of the hypermedia test page that is being displayed at any given time.

17. The method for collecting, analyzing and displaying point-of-gaze and eye-gaze to content-of-interest data according to claim 16 including for each user continuously identifying the positions of content-of-interest tags on the hypermedia test pages and continuously time-stamping the identified positions of the content-of-interest tags.

18. The method for collecting, analyzing and displaying point-of-gaze and eye-gaze to content-of-interest data according to claim 17 wherein the step of embedding content-of-interest tags in predetermined portions of the hypermedia test pages further includes the step of associating each content-of-interest tag with a high level identifier that represents high level content-of-interest.

19. The method for collecting, analyzing and displaying point-of-gaze and eye-gaze to content-of-interest data according to claim 15 including the step of monitoring the active state of each user's browser.

20. The method for collecting, analyzing and displaying point-of-gaze and eye-gaze to content-of-interest data according to claim 15 including the step of aggregating and analyzing the eye-gaze to content-of-interest data.
